(19) United States
(12) Patent Application Publication
(10) Pub. No.: US 2019/0361466 A1
(43) Pub. Date: Nov. 28, 2019

(54) REAL-TIME SYSTEM AND METHOD FOR ASSET MANAGEMENT USING UNMANNED AERIAL SYSTEMS AND EDGE COMPUTING

(71) Applicant: Raptor Maps, Inc., Somerville, MA (US)

(72) Inventors: Edward William OBROPTA, JR., Cambridge, MA (US); Nikhil VADHAVKAR, Somerville, MA (US)

(21) Appl. No.: 16/420,994

(22) Filed: May 23, 2019

Related U.S. Application Data
(60) Provisional application No. 62/675,305, filed on May 23, 2018.

(51) Int. Cl. G05D 1/12; G06N 20/00; B64C 39/02

(52) U.S. Cl. CPC G05D 1/12; G06Q 10/20; B64C 39/024; G06N 20/00

(57) ABSTRACT

Systems and methods collect and process asset data locally at an edge device and transfer details regarding detected anomalies to a database. Such edge devices include unmanned aerial systems and other self-propelled devices. Anomalies can be located precisely, classified, and de-duplicated. Systems and methods also facilitate management of efforts to address detected anomalies.

### CROSS-REFERENCE TO RELATED APPLICATIONS

This application claims priority to and the benefit of U.S. Provisional Application No. 62/675,305 filed May 23, 2018, which is incorporated herein by reference in its entirety.

### TECHNICAL FIELD

The field of invention relates to asset management, and more particularly managing assets using data collected and analyzed by an unmanned aerial system (UAS).

### BACKGROUND

Asset management generally refers to monitoring and maintenance of things of value. It can involve, among other steps, systematic approaches for developing, operating, maintaining, upgrading, and disposing of assets effectively.

One aspect of asset management can involve collecting asset performance or serviceability data to inform management decisions. The consistent and accurate collection of such asset data can be time consuming, imprecise, and costly. While increased automation and sensor capabilities are creating new opportunities for asset data collection, constraints still exist which limit the usability of collectible data.

There is a need to improve asset management by leveraging available data in a timely and efficient fashion within the constraints of the systems used for collecting and analyzing data.

### SUMMARY

The needs existing in the field are addressed by the present disclosure, which relates to systems, methods and computer usable media for utilizing UAS and edge computing to improve asset management.

In one general aspect, a UAS comprises a propeller assembly configured to propel the UAS, a location sensor configured to determine location data of the UAS, and a collection sensor configured to collect asset data associated with an asset of an asset class. The UAS also includes a UAS computer including a processor, a memory, and an interface configured to receive the location data from the location sensor and the asset data from the collection sensor. The memory stores an asset map representing the asset, anomaly data modeling anomalies associated with the asset class, and instructions when executed by the processor are configured to effectuate various operations. The operations comprise detecting an anomaly in the asset data based on the asset map and the anomaly data, classifying the anomaly based on the anomaly data, locating the anomaly based on the asset map, and generating result data including anomaly location information and anomaly classification information. The UAS also comprises a transmitter configured to transmit the result data and a power supply configured to provide power to the propeller assembly, the location sensor, the collection sensor, the UAS computer, and the transmitter.

In another general aspect, a method comprises collecting, using a collection sensor of a UAS, asset data associated with an asset of an asset class. The method further comprises detecting, using a UAS computer aboard the UAS, an anomaly in the asset data based on an asset map and anomaly data, wherein the asset map represents the asset, and wherein the anomaly data models anomalies associated with the asset class. The method further comprises classifying, using the UAS computer, the anomaly based on the anomaly data. The method further comprises locating, using the UAS computer, the anomaly based on the asset map. The method further comprises generating, using the UAS computer, result data including anomaly location information and anomaly classification information. The method also comprises transmitting the result data.

In another general aspect, a system comprises a server. The server includes an anomaly interface configured to receive anomaly result data, wherein the anomaly result data is derived from a subset of asset data by a UAS by comparing the asset data collected by the UAS to an asset map and anomaly data using a computer aboard the UAS. The server also includes an anomaly database configured to store the anomaly result data and a maintenance interface configured to provide at least a portion of the anomaly result data to a user device.

In another general aspect, a system or method is configured to facilitate management of maintenance or remediation tasks associated with identified anomalies related to an asset.

This summary is intended to provide a short description of some aspects only. Additional and alternative details will be apparent on review of other portions of this disclosure.

### BRIEF DESCRIPTION OF THE DRAWINGS

FIG. 1 is a diagram of an example system for asset management disclosed herein;

FIGS. 2A and 2B are block diagrams of an example system for asset management disclosed herein.

FIG. 3 is a block diagram illustrating an example implementation of a device which can be utilized in conjunction with or comprise a portion of systems disclosed or implement or execute methods herein; and

FIG. 4 is a block diagram of a computer system that be used to implement at least a portion of aspects herein.

FIG. 5 illustrates a flow chart of an example methodology for asset management disclosed herein; and

FIG. 6 illustrates a flow chart illustrating another example methodology for asset management disclosed herein.

### DETAILED DESCRIPTION OF ILLUSTRATIVE EMBODIMENTS

Rich data from a variety of sensors can be collected in a variety of ways to improve asset management. For example, UAS can be utilized to collect asset data in a consistent and efficient manner. However, UAS observing an asset will accumulate vast amounts of data. Value to asset managers (automated or human) is created or enhanced when the data collected is exported from the UAS and data points of interest are identified therein. To identify data points of interest, aspects herein describe the utilization of machine learning or other analyses capable of detecting, classifying, and precisely locating anomalies. The raw data from which the data points of interest are identified may exceed acceptable bandwidth requirements for real-time processing, so aspects herein also describe performance of such anomaly detection using a computer aboard the UAS and transmitting the anomaly data (but, in embodiments, not the raw data) in real-time. Anomaly data can be transmitted to a ground station linked to a server, and/or directly to networks (e.g., the Internet) for UAS possessing cellular or other network links other than a wireless connection to a ground station. In this manner anomalies can be determined in real-time or near real-time and communicated without overloading available wireless bandwidth. Determination of maintenance required based on anomaly classification can also be performed to better assist with actioning asset conditions discerned from asset data.

While aspects herein discuss the utilization of UAS, it is understood that real-time processing and bandwidth savings can be realized through the utilization of other edge devices regardless of whether or not they are unmanned or aerial. Manned aircraft, tethered balloons, kites, or ground-traveling systems (or systems which do not travel on the ground but crawl assets) can all be utilized without departing from the scope or spirit of the innovation. While certain embodiments herein only transmit anomaly data (in real-time or at all), it is understood that in bandwidth permissive environments all data collected can be transmitted, regardless of where anomaly detection is performed. For example, anomaly detection can still occur aboard a UAS, or may alternatively be performed in part or entirely at a ground station or by one or more servers.

As used here, an “asset” can be, for example, a piece of equipment, groups of pieces of equipment, a parcel or area of land, volume of space, et cetera, or combinations thereof, that can be inspected using sensors. By way of example, a photovoltaic (PV) system can include a single solar cell, which is an asset, but also strings of cells, arrays of strings, combiners, inverters, et cetera, comprising a “solar farm,” which can be an asset or multiple assets. Moreover, the surrounding space and property, which can be affected by vegetation (including overhead vegetation, which can cause shading), improper security, shifting ground or structural members, et cetera, can also comprise an asset, multiple assets, or a portion of one or more assets. Data collection and analysis regarding assets, therefore, can be referred to in singular or plural and relate to not only a particular piece but also surrounding environs or other matter that influences the condition or performance of the particular piece. In other non-limiting examples, structures, pipelines, support members, wires, utility equipment, soil, crops, et cetera can all comprise assets. An “asset class” refers to groups of like assets that degrade similarly or can be analyzed using common datasets to accurately determine condition or performance.

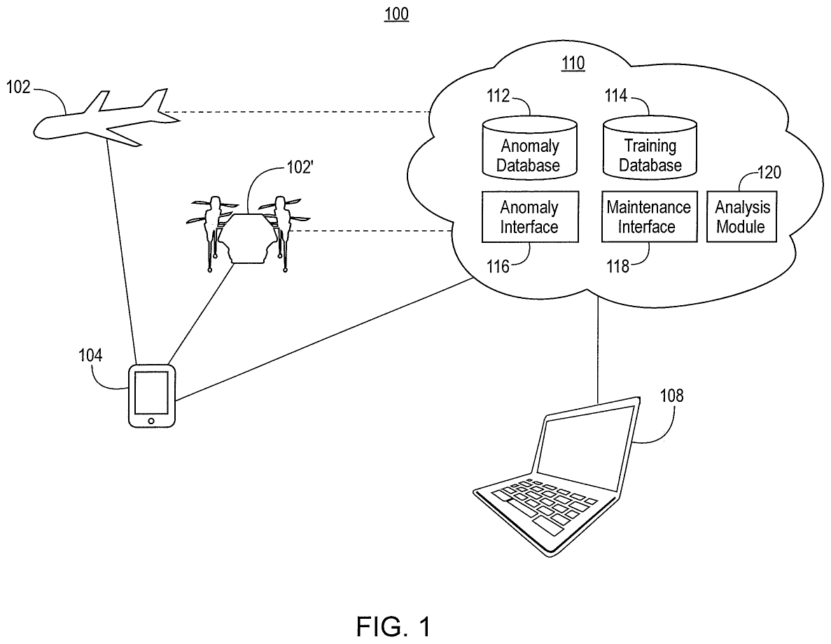

FIG. 1 illustrates an example system 100 for asset management disclosed herein. System 100 includes one or more UAS such as fixed wing UAS 102 and rotary wing UAS 102′. While fixed wing and rotary wing UAS are described, in alternative embodiments, any vehicle or sensor capable of observing an asset can be utilized. UAS 102/102′ communicate with ground station 104 and/or network 110, and ground station 104 can communicate with network 110 in combination or separately from UAS 102/102. Network 110 can include or be communicatively coupled with resources for implementing an anomaly database 112, training database 114, anomaly interface 116, and maintenance interface 118. Anomaly interface 116 receives at least anomaly result data from one or more of UAS 102/102′ and/or ground station 104.

Detected anomalies described in anomaly result data received using anomaly interface 116 are stored in anomaly database 112. Anomaly database 112 can be organized by asset type or class, by client or asset owner (e.g., users or groups of users), or other parameters. Anomaly database 112 can include an anomaly map or defect map that represents the anomalies in a visual manner on the asset from a given perspective view (e.g., top-down, elevation, et cetera).

Training database 114 can store training data for use in analyses performed herein, and may receive data from anomaly database 112, client device 108, UAS 102/102′, ground station 104, or other sources of data that can be used for training or programming anomaly recognition techniques. The training data can be used for developing anomaly data by providing, e.g., quantitative or qualitative descriptions of known anomalies or patterns suggesting anomalies. Maintenance interface 118 is configured to communicate with client device 108 to report anomaly result data for one or more assets, and can further assist with calculating the impact of anomalies and managing or prioritizing correction of anomalies.

Anomaly result data can be data arranged according to a data structure or file type. The particular parameters included in anomaly result data can vary depending on the asset class to which they relate. Anomaly result data can include state data of UAS 102/102′ from when the sensor data indicating an anomaly was collected. Such state data can include altitude, location, pitch, yaw, roll, and gimbal pitch, gimbal yaw, gimbal roll, camera information (field of view, resolution, offset from UAS body), et cetera. Anomaly result data can also include raw data, such as the best raw sensor data representing the anomaly. However, less than all raw data collected can be provided with anomaly result data, thereby reducing the amount of bandwidth required for transmission. In embodiments, anomaly result data is formatted to transmit in near real-time over a short message service (SMS) format. In embodiments, UAS 102/102′ (or, alternatively or complementarily, ground station 104) can assemble an anomaly map for local or immediate use without connectivity to network 110.

Databases 112 and 114 can be implemented on one or more servers that aggregate or store anomaly data. The aggregated anomaly data can be used to refine existing training data and provide training data to, e.g., UAS 102/102′ for purposes of identifying anomalies.

In embodiments, maintenance interface 118 can provide analytics associated with anomaly data. In the PV example discussed herein, a sum of power generation lost (e.g., 1.5 MW) can be calculated based on the anomalies present at a particular asset. Renderings of anomalies over asset maps can be provided. Instructions or recommendations for addressing anomalies can be provided in an iterative manner Such instructions can be prioritized based on various parameters, such as, e.g., restoration of maximum capability first (e.g., for PV, fixing a string that restores a majority of lost power before fixing individual cells that are not responsible for a substantial amount of loss), prioritizing service that can be completed with limited time or resources (e.g., repair personnel available for two hours with four replacement parts), et cetera. These analytics or management recommendations can be generated in a variety of locations, such as using analysis capability aboard UAS 102/102′ or using analysis capabilities in network 110 using servers such as those described herein or others. Summary reports can be generated totaling the number and type of anomalies, work required to cure the anomalies, losses caused by anomalies, et cetera.

In embodiments, analyses or calculations performed using components remote from UAS 102/102′ and/or ground station 104 can be performed using an analysis module 120, which can be implemented on any device communicatively coupled with other elements of system 100 using network 110.

In embodiments, UAS 102/102′ can be permanently stationed at an asset, and may be associated with a protective housing, charging apparatus, network connection, et cetera. Whether stationed or delivered, UAS 102/102′ can be dispatched, automatically or on demand, to perform intelligent inspections of the asset.

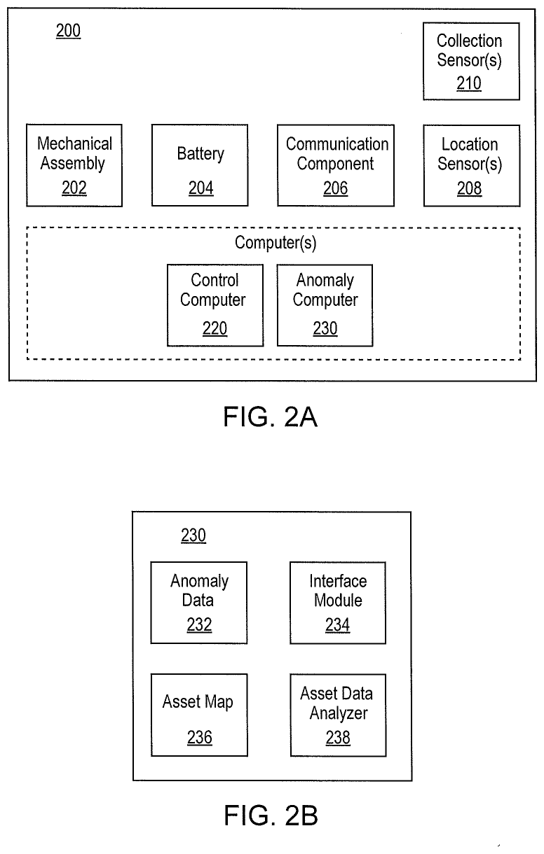

FIG. 2 illustrates a block diagram of an example system 200 for implementing asset management techniques disclosed herein. System 200 can be UAS 102/102′ or other mechanisms for collecting asset data. System 200 can include mechanical assembly 202, which can be, e.g., a propeller assembly configured to propel system 200 while it collects asset data or travels to or from asset data collection. While system 200 is described as including a mechanical assembly, it is understood that other means of moving or positioning UAS or other vehicles can be employed without departing from the scope or spirit of the innovation. Jets, mass transfer systems, or other less- or non-mechanical systems for moving systems can be employed in alternative or complementary embodiments. System 200 can also include battery 204 or another power supply (e.g., fuel cell, combustion, solar cell, et cetera) configured to provide power to the various components of system 200. In embodiments, multiple power supplies can be provided (e.g., battery and engine).

System 200 also includes communication component 206 configured to communicate with one or more of a ground station, a network, or other computer or electronic components. Communication component 206 can at least transmit anomaly result data and/or sensor data, but may also receive or transmit various other data, including flight or mission instructions, position or status information, et cetera.

System 200 includes various sensors such as location sensor(s) 208 and collection sensor(s) 210. Location sensor(s) 208 are configured to determine location data of the system 200 at least while system 200 collects asset data. Location sensor(s) 208 can include various global positioning system (GPS) receivers, which in embodiments can be high-accuracy GPS receivers. Accelerometers, gyroscopes, magnometers, altimeters, barometers, and other sensors can also assist with determination of location, the nature of travel, and the environment conditions associated with travel. In embodiments, location sensor(s) 208 can include software for determining or tracking location, such as machine vision software that matches information from sensors on system 200 to maps.

Collection sensor(s) 210 are configured to collect asset data associated with an asset of an asset class. Collection sensor(s) 210 can include, e.g., thermal cameras, red-green-blue (RGB) cameras, radar systems, lidar systems, laser systems, infrared systems, et cetera, or any sensor capable of collecting data about an asset from the system 200, which can (but need not) be overflying or orbiting the asset for collection of asset data. Asset data can be raw sensor data that images or assesses an asset, and can include, but is not limited to, still images, video, infrared or near infrared images, thermal images, data discerned from reflected energy such as sound waves, radar, lidar, lasers, et cetera. Asset data can be collected as a stream of images or a stream of asset data organized by time. In embodiments, asset data may alternatively or complementarily be organized by location or orientation (e.g., of system 200, of elements of system 200 such as a sensor) or other variables. Collection sensor(s) 210 can have a fixed or variable orientation aboard system 200. System 200 can change its orientation to direct collection sensor(s) 210 to a particular view, or one or more of collection sensor(s) 210 can be movable with respect to system 200. In embodiments, a fixed configuration of one or more of collection sensor(s) 210 can be selected to provide particular perspectives of an asset when system 200 is traveling in an expected manner (e.g., level flight). Such particular perspectives can minimize interference by system 200, provide an easily-referenced view for more precise location of the asset or portions of the asset, or provide a better view of assets such as PV modules that may vary in orientation themselves. With specific regard to PV modules, solar panels can be angled or track the sun, and so a camera pointed “straight down” may be misaligned from the plane of the solar panel. To capture a consistent view of solar panels, sensors for collecting PV asset data can be pitched or tilted, based on the asset parameters and/or time of day/location of sun to more closely align with the angle of the solar panels. Control computer 220 or other aspects can also orient collection sensor(s) 210 and/or modify travel paths of system 200 to improve the quality of sensor data collection, such as by reducing glare. Based on asset data including asset map 236, which can include known tilt angles of solar panels, the time of day, the location of the system 200, and the location of the sun, glare can be estimated and travel paths for system 200 or sensor orientations for collection sensor(s) 210 can be calculated and utilized to minimize glare or other undesirable effects.

System 200 can also include one or more computers. As illustrated, system 200 includes control computer 220 and anomaly computer 230. However, the functionality of these computers can be combined in a single computer, or additional computers could be utilized aboard system 200 without departing from the scope or spirit of the innovation. In embodiments, one or both of control computer 220 and/or anomaly computer 230 can comprise a portion or all of a UAS computer.

Control computer 220 is configured to control mechanical assembly 202 and can be, e.g., a flight assembly configured to control propeller operation. Control computer 220 can cause system 200, using mechanical assembly 202, to travel a predetermined route (e.g., a waypoint mission) or on-the-fly route (e.g., based on recognition of the asset or other features, manually controlled, et cetera) for asset data collection, as well as controlling travel to assets and return from assets. In embodiments, control computer 220 can control one or more of position (e.g., latitude and longitude), altitude, orientation, sensor orientation (e.g., as distinguished from the overall orientation of system 200), et cetera, using mechanical assembly 202 or other control components. Control computer 220 can receive input or data from, e.g., a ground station or server, stored instructions in local memory, location sensor(s) 208, collection sensor(s) 210, or other sources to calculate the control signals required to actuate mechanical assembly 202 or other components to travel intended routes and providing intended views for collection. In this regard, control computer 220 can include an interface (such as an application programming interface (API)) that allows inputs to drive control. In embodiments, control computer 220 assesses the feasibility of inputs and can accept or reject an input based on the capabilities of system 200/mechanical assembly 202, the available resources of system 200, or other parameters. Commands or preprogrammed information used by control computer 220 can also include instructions to inspect a particular asset subset (e.g., all PV modules associated with a particular inverter, particular modules according to owner numbering or nomenclature), instructions to inspect previously-detected anomalies to confirm the anomaly or repair thereof, instructions to map only particularly-classified anomalies (e.g., map hail damage, which may be related to an insurance claim, while excluding vegetation overgrowth)

In embodiments utilizing flight plans, parameters can be determined automatically based on UAS capabilities and best matches for sensor capabilities to collect data corresponding to the training data, or parameters can be set according to predetermined routes. Parameters can include altitude, overlap, speed, sidelap, camera parameters, attitude, orientation, approach angle, travel direction, number of overflights, et cetera.

Control computer 220 can steer or fly an iterative collection loop. The collection loop can have multiple subcomponents, such as a detailed inspection (e.g., normal), overview inspection (e.g., faster but less detailed), and targeted inspection (e.g., focusing on certain areas based on specific instructions, a report of an anomaly such as by an aberrant supervisory control and data acquisition (SCADA) reading, or the real-time detection of a suspected anomaly). In embodiments, control computer 220 can modify a route in real-time to collect higher granularity sensor data if an anomaly is detected.

In UAS embodiments, control computer 220 can use terrain information from asset map 236 to maintain constant vertical separation regardless of the rise and fall of the ground below (with respect to, e.g., sea level) and associated assets. This also improves the safety of UAS (in embodiments where system 200 includes UAS) by allowing for low-altitude inspection of uneven terrain with risk concern of an air-ground collision.

Anomaly computer 230 can determine, aboard the system 200 and without exporting collected data elsewhere, anomalies in observed assets. As shown in FIG. 2B, anomaly computer 230 includes interface 234 configured to receive the location data from the location sensor and the asset data from the collection sensor.

Anomaly computer 230 also includes asset map 236 representing the asset. Asset map 236 can represent the asset or multiple assets in 2D space, 3D space, computer aided design diagrams, engineering drawings, et cetera, and may or may not include absolute location data related to the asset. Asset map 236 can include geospatial, electrical, or other technical details regarding the asset. In embodiments, asset map 236 can be or include one or more digital twins of one or more assets. Asset map 236 can include a terrain model including site grading/relief. The terrain model can include not just the ground, but the height of the asset or particular areas or components of a given asset. In embodiments where system 200 is an aerial platform, knowledge of the distance to assets is useful to processing images, and can further inform system 200 (e.g., control computer 220) when a lower pass is necessary to improve sensor data granularity.

Anomaly computer 230 can also include anomaly data 232 modeling anomalies associated with at least an asset class of the asset. Anomaly data 232 can be training data for machine learning or artificial intelligence in embodiments, or may be other databases used to assist with the identification, location, and classification of anomalies identified on, in, or related to an asset. Anomaly data 232 can be based on an asset type, which is described in greater detail regarding examples hereafter.

In embodiments, anomaly data 232 can comprise a database of known anomalies associated with an asset class to define anomaly classifications based on their characteristics as detected by collection sensor(s) 210. In embodiments, anomaly data can also include locations of previously-found anomalies. The known anomalies can be used for pattern-matching or use with a neural network trained to the example anomalies. Different classifications of anomalies may also impact more assets or more of a single asset (e.g., for PV examples, cell or sub-module up to larger patterns impacting strings, combiners, inverters, or the entire solar farm).

Data can be pre-loaded to system 200 for particular missions or collection efforts, and changed or supplemented for different missions. Anomaly data 232, asset map 236, and even the algorithms or techniques used by analyzer 238 can all be updated to properly collect and analyze information on different assets. Further, geographic data geographic information system (GIS) data, terrain data (including relief and other three-dimensional aspects), et cetera. In this way, system 200 is initialized for the particular asset and asset class at the particular location in which it will operate. Pre-loading or initialization can be performed using a network connection, removable media, or other means.

Anomaly computer 230 also includes asset data analyzer 238, which can include a processor and/or executable instructions. Asset data analyzer 238 is configured to effectuate operations comprising at least detecting an anomaly in the asset data (collected by collection sensor(s) 210 and received using interface 234) based on asset map 236 and anomaly data 232. In embodiments, asset data analyzer 238 can be or include a trained machine learning classifier, neural network, et cetera. The operations effectuated by asset data analyzer 238 can also comprise classifying an identified anomaly based on the anomaly data. Classification includes not only identifying the presence of an anomaly, but determining the anomaly type based on previous data (e.g., matching or similar anomaly signatures or patterns). Classification will depend on the particular application. However, for the PV example discussed herein, classifications of anomalies can include cell hot spots, activated bypass diodes, shading, string outages, reverse polarity, string combiner issues, offline inverters, tilt tracker issues, module soiling and debris, module cracking, module delamination, site shadowing, site issues such as flooding or security problems such as broken fences, site racking issues, missing modules, vegetation growth, et cetera.

Operations effectuated by asset data analyzer 238 can also include locating the anomaly based on asset map 236. Based on the location of system 200, the particular perspective of sensor data collected, and/or asset map 236, anomalies can be precisely located within the asset. In embodiments using sensors providing a visual representation of the asset, the stream of sensor data can identify each segment (e.g., pixel) of the representation as having a particular location.

The operations effectuated by asset data analyzer 238 can also comprise determining a confidence level associated with at least one of the anomaly location information and the anomaly classification information. The identification of an anomaly, classification of the anomaly, and/or location of the anomaly can be associated with a confidence. The confidence can be calculated using operations effectuated by data analyzer 238, and indicates the probability that the identification, classification, and/or determination are correct. In embodiments, the confidence can be a value between 0 and 1, with 0 meaning that no anomaly is believed to be present, 0.5 meaning there is an even chance that an anomaly (or an anomaly with the pertinent classification) is present at a given location, and 1 meaning there is near certainty regarding the classification and/or location of the anomaly.

The operations effectuated by asset data analyzer 238 can also comprise generating result data including anomaly location information and anomaly classification information. In embodiments, the anomaly location information describes the anomaly with respect to asset map 236. The result data can be formatted in a proprietary data structure or fill one or more fields, and can be transmitted with or without corresponding raw sensor data or calculations. In this manner, the payload of data transmitted wirelessly can be dramatically reduced from that which is necessary to stream raw sensor data.

The operations effectuated by asset data analyzer 238 can also comprise locating one or more additional anomalies in the asset data based on the asset map and the anomaly data. Additional anomalies can be the same anomaly located in a different portion of the collection stream, or can be different anomalies. Where different anomalies are located, new entries or results can be added to anomaly result data. Where the same anomalies are located (e.g., multiple anomalies identified at a common location), all data concerning anomalies at that location can be merged and analyzed together, and/or the different detections can be analyzed separately. In this manner, the confidence regarding particular anomalies present at a particular location can be improved (e.g., the classification or location can be refined) and/or the presence of multiple anomalies can be identified (e.g., for PV examples, cracked glass in combination with shading). Once analysis is complete, affected assets are indicated as possessing anomalies only once to prevent over-counting and inaccurate reporting of anomalies.

In this regard, the operations effectuated by asset data analyzer 238 can also comprise modifying the anomaly location information or the anomaly classification information based on locating the anomaly and locating the one or more additional anomalies. Such modification can be based on the reduction of error or identification of residual error based on multiple sensor readings indicative of an anomaly at a single point. Furthermore, anomaly result data can be modified where patterns of anomalies over different assets or different portions of an asset indicate a larger systemic anomaly rather than just the individual discrete anomalies in isolation.

In some embodiments where a different classification of defect exists in the same location, the anomaly result data can map or record both (e.g., diode failure within a string failure), or replace the existing anomaly with a new anomaly, if the confidence level for the new classification is higher. In embodiments where a subset of raw sensor data is provided as evidence of the anomaly reported, the particular image or other sensor data identifying the anomaly (e.g., image that is associated with the defect) may also be replaced by an image or other sensor data that more clearly illustrates the defects. This association may also be part of an anomaly map that can be created by consolidating reported anomalies and/or overlaying anomalies on asset map 236.

In embodiments, a tolerance or residual error can be calculated by operations effectuated by asset data analyzer 238. The residual error can be, e.g., a determination of how over-sized, under-sized, or off-center a detected anomaly may be. Where the residual error concerning location exceeds a tolerance for the particular application (e.g., for PV applications, individual panels may be 3-5 feet across), information may be provided to control computer 220 to perform a more detailed inspection to enable clear location of the anomaly.

The operations effectuated by asset data analyzer 238, when multiple anomalies are detected, can also comprise deduplicating the anomaly and the one or more additional anomalies before generating the result data, wherein the one or more additional anomalies includes two or more views of the asset, and wherein the locating the anomaly and locating the one or more additional anomalies identifies the anomaly two or more times based on separate portions of the asset data. This allows confirmation of each reported anomaly's uniqueness, improves reporting avoids cluttering anomaly databases or skewing training data based thereon, prevents queuing of redundant work orders, et cetera.

The operations effectuated by asset data analyzer 238 can also comprise projecting the asset data into three-dimensional space based on the asset map and location data. Such projection can allow the assignment of location data (e.g., GPS data to each pixel or element of sensor data (or groups of pixels or elements) for precise anomaly location. In embodiments, the orientation of collections sensor(s) 210 (by independently orienting collection sensor(s) 210 or based on its relative orientation with respect to system 200 and the absolute orientation of system 200) can be used to assist with the 3D mapping of sensor data and assignment of segment-by-segment location for each.

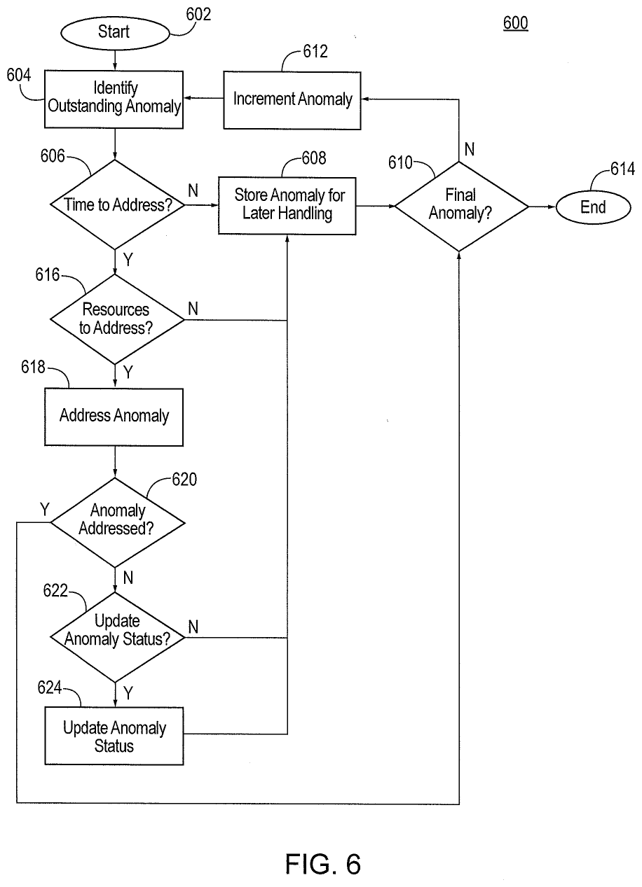

Operations effectuated by asset data analyzer 238 can also include generating a work order based on the anomaly result data. In embodiments, the work order can be transmitted in combination with or in lieu of the anomaly result data. Transmission can be provided to an owner, a party responsible for asset maintenance, or a work database in a network. In embodiments, a decision-making model, work order prioritization analysis, or similar functionality (as described in, e.g., FIG. 6) can be implemented in asset data analyzer 238 or other components of system 200. Alternatively such aspects can be implemented at any location of system 100.

In alternative or complementary embodiments, some or all of the functionality of asset data analyzer 238 (or other components) can be implemented at a ground station or other component. Such can occur where, for example, a dedicated, high-bandwidth link exists between system 200 and other components, allowing more data to be streamed in real-time while avoiding bandwidth intensive transmissions on the next “hop” between the ground station (or other components) and the network or server that receives anomaly result data. In alternative or complementary embodiments, the location at which processing or storage occurs can vary based on available bandwidth. In environments where bandwidth is unrestricted, more or all raw sensor data can be provided directly to a network or cloud. In environments where bandwidth is restricted, only anomaly data is transmitted to a network or cloud. Changes between where processing occurs and what data is transferred to a network can vary in real-time based on available bandwidth.

The benefits of systems such as systems 100 and 200 (as well as methodologies described hereafter) can be better appreciated in view of an example concerning renewable energy assets, and particularly photovoltaic (PV) systems (i.e., “solar farms”). Where an asset or group of assets involves dozens or hundreds of solar panels over a large distance, identifying underperforming or malfunctioning assets is challenging. The challenge is compounded when maintenance personnel attempt to locate a particular panel within large groups of panels. Moreover, if inspections are required to identify all panels with potential anomalies, it is impossible to predict the time and resources required to perform maintenance, and so the anomalies may require multiple trips by maintainers to correct. Efforts to automate identification of anomalies are stymied because of, e.g., difficulty orienting sensors in a manner allowing detailed inspection of multiple panels. Current techniques can be as labor intensive as “I-V curve tracing,” whereby teams of human technicians open energized combiner boxes and performs electrical testing on “strings” (PV modules wired in series) to determine whether power is being generated to specification. Technicians also perform “site walkdowns” to check for visible problems such as damaged fences, shadows obscuring panels, environmental issues such as flooding, racking issues (e.g., movement of posts or structural members), module damage (e.g., shattered glass on panel), soiling, vegetation overgrowth, et cetera. Site walkdowns are also time consuming, lack a systematic and standardized approach, do not provide complete coverage, and only indicate what technicians can observe from their perspective on the ground with their eyes. The sum total of PV site inspection does not provide comprehensive or granular views of asset performance, makes it difficult to isolate the root cause of out-of-spec power, and results in a low percentage of PV panels being tested in any given year. Remote system monitoring, such as SCADA platforms, have a high degree of noise in the signal, resulting in hundreds or even thousands of alerts per day, rendering their data inactionable. The installation of health sensors at each module and sub-module (e.g., PV cell) is extremely expensive and may become bandwidth intensive. The result of these practices and constraints is a long delay between when a panel becomes degraded and when a work order is actioned to correct the degradation.

Aerial solutions, or other solutions using wide views of large portions from useful perspectives (with either static or mobile collection devices) may alleviate some of these inefficiencies. However, placing a camera on a drone is insufficient because of difficulty maintaining connectivity or providing sufficient bandwidth to stream, in real-time, all collected sensor data to a server for analysis.

Systems 100 and 200, and the methodologies disclosed herein, cure these problems by collecting rich sensor data which is processed to small-payload anomaly result data that are transmitted and aggregated promptly and efficiently. The efficiencies realized allow more comprehensive and frequent inspections, and expedite the handling of repairs or remediation.

In PV examples (and others), anomaly data 232 can be specifically relevant to the application. Further, asset map 236 can bear a variety of information used in analyses and detailed location of particular assets or asset subcomponents. For example, the make, model, and composition of photovoltaic (PV) modules influences the failure mode and rate; thin-film modules and polycrystalline modules delaminate, crack, heat, and degrade in different patterns, and so require different anomaly data. Following a complementary or similar example, inverters have different failure modes, and so anomaly data relevant to the particular inverter type will assist with anomaly detection for assets including that inverter type. Wiring architecture is relevant to determining whether failures are local cells or series, such as when modules are wired in strings with multiple strings joined at combiners and multiple combiners joined at an inverter. Tracker information (e.g., single- or dual-axis tracker) and site orientation (e.g., fixed tilt) can be used to correct images or avoid imperfections such as glare by adjusting system gimbal in real-time (e.g. mid-flight) to avoid glare and improve photographic, thermographic, or other sensor results. Tracker information and site orientation data can also be used to determine whether or not a defect has occurred in a particular section of racking with respect to tilt (e.g., tracker motor error). Construction date can also be used to refine or modify analyses inasmuch as for PV sites most degradation occurs in the first two years and older sites are expected to have a higher number of anomalies (which may influence confidence and change classification details as to particular anomalies). The combination of construction date and location can allow for estimation of project finance (such as Power Purchase Agreement (PPA)) rate, allowing for quantification or valuation of losses from PV system defects. Location is relevant to anomaly data inasmuch as local environmental factors influence the type and nature of site and module degradation. Location can be further refined if anomaly data 232 and/or asset map 236 includes an owner numbering or naming convention, allowing the location of particular components according to an owner's system or arrangement.

In the case of PV inspection, a combination of image processing steps, thermography considerations in the case of thermal imaging, and a convolutional neural network trained to classify PV system anomalies can be used to detect anomalies in the image frame either on-board computer(s) of system 200 or companion computers/ground station computers receiving of a live image/video feed. If anomalies are detected, they are projected onto the ground plane or onto the asset. The anomaly database is then updated (e.g., for this particular image, these defects have been found in these locations on the ground plane). The anomaly database receives this information and determines the location of the anomaly with respect to asset map 236 (e.g., digital asset drawing contextualizing the anomaly, as opposed to only providing a GPS location). If the anomaly is new, the anomaly database (and/or, e.g., anomaly map or defect map that can exist independently or be derived therefrom) is updated using anomaly result data that may be transmitted over wireless links such as WiFi, cellular/mobile data links, telemetry connections (e.g., 5.4 GHz, 933 MHz), Bluetooth, or any other communication protocol. In one embodiment, the anomaly map can update on a device or ground station in use by a client or pilot.

While aspects herein provide solar energy as an example, it is understood that techniques can be applied to other fields and assets without departing from the scope or spirit of the innovation. For example, agricultural studies and assess soil or crop development (e.g., seed inspector dispatches drone to locate and classify areas of flooding or suspected disease and dispatch a work order to spray pesticides or re-fertilize). In another example, the geometries and function of wind turbines (on, i.e., “wind farms”) can be analyzed as one or more assets. Buildings and structures or portfolios thereof can also be analyzed and inspected for structural integrity, performance, energy efficiency, et cetera. Distribution infrastructure for commodities such as, e.g., electricity, water, oil, and gas can be inspected, as can functional locations associated therewith such as facilities for, e.g., harvesting, refining, transmitting, distributing, and treating, such commodities. In another example, an oil pipeline can be an asset, and asset data can indicate the probability of a leak or other failure.

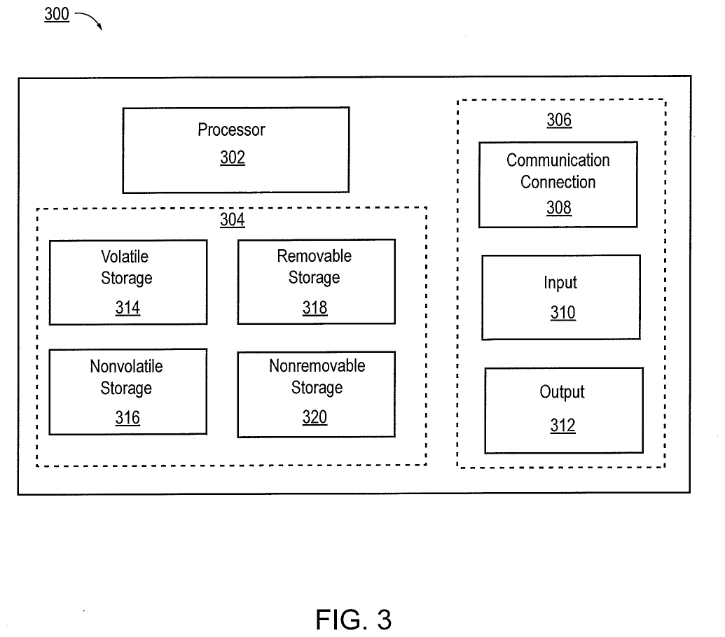

Aspects disclosed herein can be implemented using computer devices and networks. FIG. 3 illustrates a device 300. Device 300 may comprise all or a part of modules or components herein. Device 300 may comprise hardware or a combination of hardware and software. The functionality to facilitate telecommunications via a telecommunications network may reside in one or combinations of links, portals, or connections. Device 300 depicted in FIG. 3 may represent or perform functionality of an appropriate device 300, or combination of modules or components herein. It is emphasized that the block diagram depicted in FIG. 3 is an example and not intended to imply a limitation to a specific implementation or configuration. Thus, device 300 may be implemented in a single device or multiple devices. Multiple network entities may be distributed or centrally located. Multiple network entities may communicate wirelessly, via hard wire, or any appropriate combination thereof.

Device 300 may comprise a processor 302 and a memory 304 coupled to processor 302. Memory 304 may contain executable instructions that, when executed by processor 302, cause processor 302 to effectuate operations associated with aspects disclosed herein. As evident from the description herein, device 300 is not to be construed as software per se.

In addition to processor 302 and memory 304, device 300 may include an input/output system 306. Processor 302, memory 304, and input/output system 306 may be coupled together (coupling not shown in FIG. 3) to allow communications there between. Each portion of device 300 may comprise circuitry for performing functions associated with each respective portion. Thus, each portion may comprise hardware, or a combination of hardware and software. Accordingly, each portion of device 300 is not to be construed as software per se. Input/output system 306 may be capable of receiving or providing information from or to a communications device or other network entities configured for telecommunications. For example input/output system 306 may include a wireless communications (e.g., WiFi/2.5G/3G/4G/GPS) card. Input/output system 306 may be capable of receiving or sending video information, audio information, control information, image information, data, or any combination thereof. Input/output system 306 may be capable of transferring information with device 300. In various configurations, input/output system 306 may receive or provide information via any appropriate means, such as, for example, optical means (e.g., infrared), electromagnetic means (e.g., RF, WiFi, Bluetooth®, ZigBee®), acoustic means (e.g., speaker, microphone, ultrasonic receiver, ultrasonic transmitter), or a combination thereof. In an example configuration, input/output system 306 may comprise a WiFi finder, a two-way GPS chipset or equivalent, or the like, or a combination thereof.

Input/output system 306 of device 300 also may contain communication connection 308 that allows device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with aspects described herein. For example, processor 302 may be capable of, in conjunction with any other portion of device 300, managing social media communications as described herein.

Memory 304 of device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a nonremovable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by device 300. Memory 304 may comprise executable instructions that, when executed by processor 302, cause processor 302 to effectuate operations for, e.g., listening to social media activity.

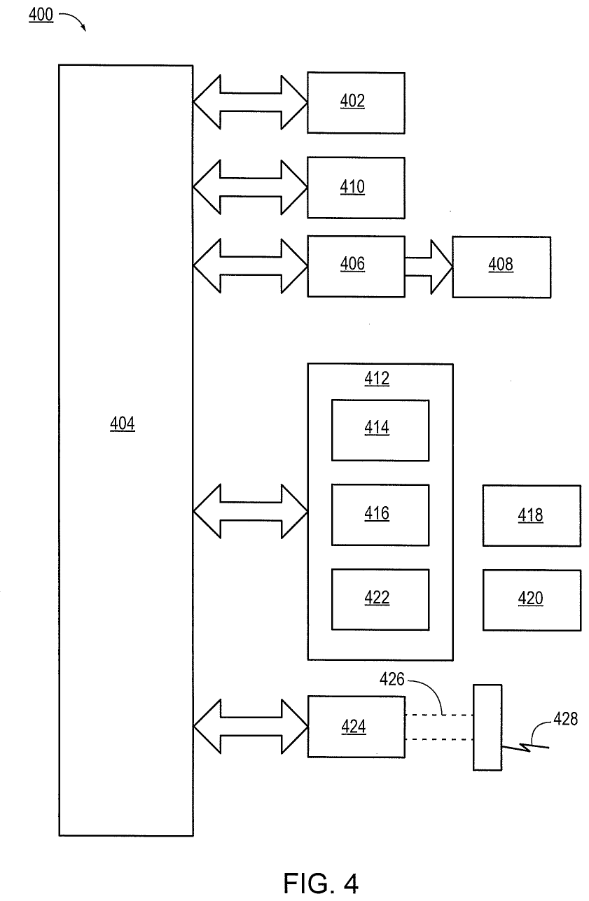

FIG. 4 illustrates a computer-based system 400 that may constitute, include parts of, or be used to realize one or more of aspects of, e.g., systems 100 or 200, or methodologies and techniques described herein. Computer-based system 400 includes at least one processor, such as a processor 402. Processor 402 may be connected to a communication infrastructure 404, for example, a communications bus, a cross-over bar, a network, or the like. Various software aspects are described in terms of this example computer-based system 400. Upon perusal of the present description, it will become apparent to a person skilled in the relevant art(s) how to implement the present disclosure using other computer systems or architectures.

Computer-based system 400 includes a display interface 406 that forwards graphics, text, or other data from communication infrastructure 404 or from a frame buffer (not shown) for display on a display unit 408.

Computer-based system 400 further includes a main memory 410, such as random access memory (RAM), and may also include a secondary memory 412. Secondary memory 412 may further include, for example, a hard disk drive 414 or a removable storage drive 416, representing a floppy disk drive, a magnetic tape drive, an optical disk drive, etc. Removable storage drive 416 reads from or writes to a removable storage unit 418 in a well-known manner Removable storage unit 418 may represent a floppy disk, magnetic tape, or an optical disk, and may be read by and written to by removable storage drive 416. As will be appreciated, removable storage unit 418 includes a computer usable storage medium having computer software or data stored therein.

In accordance with various aspects of the present disclosure, secondary memory 412 may include other similar devices for allowing computer programs or other instructions to be loaded into computer-based system 400. Such devices may include, for example, a removable storage unit 420 and an interface 422. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 420 to computer-based system 400.

Computer-based system 400 may further include communication interface 424. Communication interface 424 may allow software or data to be transferred between computer-based system 400 and external devices. Examples of communication interface 424 include, but may not be limited to a modem, a network interface (such as an Ethernet card), a communications port, a Personal Computer Memory Card International Association (PCMCIA) slot and card, or the like. Software or data transferred via communication interface 424 may be in the form of a number of signals, hereinafter referred to as signals 426, which may be electronic, electromagnetic, optical or other signals capable of being received by communication interface 424. Signals 426 may be provided to communication interface 424 via a communication path (e.g., channel) 428. Communication path 428 carries signals 426 and may be implemented using wire or cable, fiber optics, a telephone line, a cellular link, a radio frequency (RF) link, or other communication channels.

In this document, the tams “computer program medium” and “computer usable medium” are used to generally refer to media such as removable storage drive 416, a hard disk installed in hard disk drive 414, or the like. These computer program products provide software to computer-based system 400. The present disclosure is directed to such computer program products.

Computer programs (also referred to as computer control logic) may be stored in main memory 410 or secondary memory 412. The computer programs may also be received via communication interface 404. Such computer programs, when executed, enable computer-based system 400 to perform the functions consistent with the present disclosure, as discussed herein. In particular, the computer programs, when executed, enable processor 402 to perform the features of the present disclosure. Accordingly, such computer programs represent controllers of computer-based system 400.

In accordance with an aspect of the present disclosure, where the disclosure is implemented using a software, the software may be stored in a computer program product and loaded into computer-based system 400 using removable storage drive 416, hard disk drive 414, or communication interface 424. The control logic (software), when executed by processor 402, causes processor 402 to perform the functions of the present disclosure as described herein.

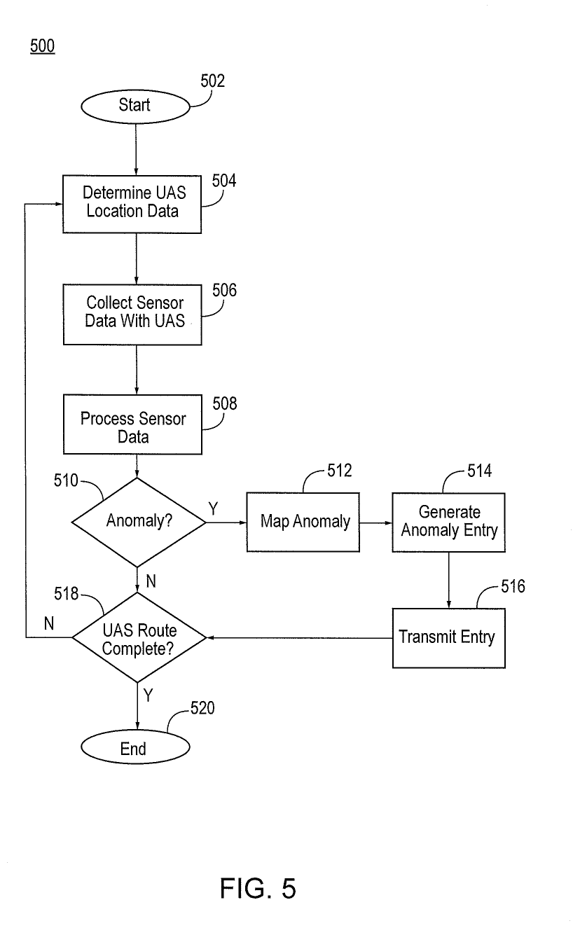

FIG. 5 illustrates a flow chart of an example methodology for asset management disclosed herein. Methodology 500 begins at 502 and proceeds to 504 where a UAS location is determined. UAS location can be tracked during collection of sensor data. At 506, collection of asset data using the asset data collection sensors of the UAS occurs. In embodiments, location monitoring and collection occur simultaneously. One or more sensors can be utilized for each, and in embodiments multiple sensors can be used for location tracking and/or collection of asset data, either to provide multiple opportunities for analysis or for combined analyses to corroborate, refine, or increase the detail of the results of analyses.

At 508, sensor data is processed aboard the UAS. Processing can occur by comparing the sensor data to at least known anomaly data for an asset class including the asset being inspected. Such processing can be performed using comparators, trained classifiers, neural networks, et cetera, to match collected data to data representing known anomalies. In embodiments, an asset map (or other representation of the asset) can be used in processing at 508 as well. At 508, the asset map may assist with discovery of systemic anomalies involving more than a discrete point in or portion of the asset, or the identification of anomalies involving multiple portions of the asset (e.g., in PV examples, string, combiner, inverter).

At 510 a determination is made if an anomaly has been found based on analysis of collected sensor data. If an anomaly is found, it is classified (e.g., the type of anomaly for the particular asset class is identified) and located (e.g., on an asset map, based on an absolute GPS location). In embodiments, anomaly data can be located with reference to an asset map. Data representing an anomaly can be projected into three dimensional space or located on a segment-by-segment (e.g. pixel-by-pixel for image sensors) basis. If no anomaly is found, methodology 500 proceeds to 518 where a determination is made as to whether the UAS' route is complete. If so, methodology 500 ends at 520. If the route is not complete, the methodology can recycle to 504 or other aspects of methodology 500.

If the determination at 510 returns positive and an anomaly is found, methodology 500 proceeds to 512 where the anomaly is mapped. Mapping the anomaly can include providing a location of the detected anomaly with reference to the asset or an absolute location, overlaying the anomaly on an asset map, et cetera. Thereafter, an anomaly entry can be generated, according to a particular data structure or type for the pertinent application, can be generated at 514. A confidence associated with anomaly identification, classification, or location can also be generated based on the probability that the detected anomaly exists at the location. After the anomaly entry or anomaly result data is generated, it can be transmitted, without all raw sensor data collected, at 516. By transmitting data identify, classifying, and locating anomalies using the UAS, and storing anomaly data in a low-payload data structure, near real-time feedback for reporting anomalies can be provided. Thereafter, methodology 500 proceeds to 518 as described above.

If the route is incomplete, at 506, methodology 500 can include locating one or more additional anomalies in the asset data based on the asset map and the anomaly data.

In embodiments where multiple anomalies are discovered, methodology 500 can include deduplicating the anomaly and the one or more additional anomalies before generating the result data, wherein the one or more additional anomalies includes two or more views of the asset, and wherein the locating the anomaly and locating the one or more additional anomalies identifies the anomaly two or more times based on separate portions of the asset data.

Alternative or complementarily, where methodology 500 locates multiple anomalies, the methodology can include modifying the anomaly location information or the anomaly classification information based on locating the anomaly and locating the one or more additional anomalies.

FIG. 6 illustrates a flow chart of another example methodology for asset management disclosed herein. FIG. 6 provides techniques for on-site work prioritization, which can be solved using a UAS, ground station, or network resources, and provided to an owner or maintenance personnel for action. Work orders can be issued to address particular anomalies or defects. In a PV example, if one defect is affecting 80% of the loss power capacity of the PV system, the algorithm can assess if the technician can actually perform the work immediately on-site, by having prior knowledge that the spare part is available and there is enough time to perform the fix. The work order algorithm can then schedule a fix for a secondary issues and include the information regarding appropriate tools. Remaining issues can be sent and logged in the asset management system to monitor defect progression over time and be included in subsequent follow-up inspections.

If not enough prior information is available to confidently make a decision, a work order message can be provided or flagged for review. To assist with review, or to assist maintenance personnel based on a completed work order, an asset map displaying detected anomalies can be provided. In bandwidth permissive environments where all data can be provided (in real-time or over a period of time), original video, raw images, or raster image map can be sent.

In this regard, methodology 600 can begin at 602 and proceed to 604 where an un-addressed anomaly is identified. Anomalies can be identified from an anomaly database. The anomaly database can include a prioritized ranking of anomalies. Alternatively or complementarily, methodology 600 can be used to identify or modified priorities. A new or existing work order can be used to identify an anomaly suitable for addressing. At 606, a determination is made as to whether available maintenance personnel (e.g., on-site, nearby, or assigned to the task) to fix the anomaly. This determination can be based on the classification of the anomaly (from anomaly result data) and historical data related to time for personnel to address particular anomalies. If, based on the type of anomaly and historical averages (with or without additional context for particular owners, locations, crews, et cetera) it is determined that sufficient time address the anomaly exists, methodology 600 proceeds to 616 where a determination is made as to whether resources are available to fix the anomaly (e.g., tools, spare parts, et cetera). The determination at 616 can include a lookup of known or historical resources required to fix similarly-classified anomalies. In embodiments, the determinations at 606 and 616 can be reversed, with a determination of resources made before assessing time.

If either of the determinations at 606 or 616 return negative, methodology 600 advances to 608 where a record of the anomaly can be stored for later treatment (e.g., indication that the anomaly is not resolved and preservation or escalation of work order). When stored for later handling, the anomalies can be prioritized. Prioritization can be based on, e.g., the time or resources needed to fix an anomaly, the amount of capability restored based on fixing the anomaly, the time since an anomaly was discovered, et cetera. The stored anomaly list can be reused in a subsequent iteration of methodology 600 (e.g., beginning at 602) in embodiments.

Methodology 600 then proceeds to 610 where a determination is made as to whether the anomaly assessed was the final anomaly to be addressed. If so, methodology 600 proceeds to 614 where the methodology ends. If not, methodology 600 proceeds to 612 where an anomaly counter or record is incremented, and the methodology moves to the next anomaly before returning to 604.

If the determination at 616 returns positive, methodology 600 proceeds to 618 where the anomaly is addressed by maintainers. At 620, after the maintainers complete their work, a determination is made as to whether work on the anomaly is completed (e.g., anomaly is resolved). If the determination at 620 returns positive, methodology 600 proceeds to 610.

If the determination at 620 returns negative, a determination is made as to whether to update the anomaly status at 622 (e.g., whether the anomaly been improved or changed). If so, the status can be updated at 624 with relevant data stored thereafter at 608. If not, the prior anomaly status can be stored at 608.

In embodiments, the results of methodology 600 can be synched to a management server or database. Further, in embodiments, interactive checklists can be generated to locate and describe anomalies and track addressing thereof by involved personnel or systems. These can be implemented using, e.g., databases or interfaces depicted in FIG. 1 or elsewhere in this disclosure.

In an embodiment alternative to the depiction of methodology 600, a method can start at 602, identify anomalies at 604, and thereafter determine whether the time and resources are available to address the anomaly at 606 and 616 given a particular state of maintenance (or other) personnel (e.g., their location, their working hours remaining, their team capabilities, their tools and parts available, et cetera). However, rather than addressing (or instruction addressing) of any particular anomaly, all anomalies are assessed for capability to repair before a decision is made. Thereafter, based on the capability assessment, all anomalies capable of being fixed are prioritized, and work can commence based on priority. In embodiments of methodology 600 and the modified method described in this paragraph, identification of anomalies at 604 can include filtering the anomalies to ensure the anomalies considered are sufficiently urgent to be prioritized. Filtering can include, e.g., determining that an impact of a particular anomaly exceeds a threshold (e.g., in PV examples, loss greater than 500 KW). The modified method described proceed to 608 whether sufficient time or resources are available, but store anomalies (or the filtered subset of anomalies) as either “addressable” (if time and resources are both determined to be sufficient at 606/616) or “not-addressable”/“follow-up” (if one or both of time or resources are determined insufficient at 606/616). In embodiments, the modified methodology can proceed to 618 from the list of “addressable” anomalies.

A method herein can include providing an integer or value (for use with a counter) for defects or anomalies discovered during inspection. To filter the defects for prioritization, a determination on a first defect can be made as to whether the defect is new and whether it is significant (e.g., power loss greater than 500 KW). If the defect is not new or significant, it can be disregarded, and a counter is incremented. The next defect having an integer or other value matching the counter is then assessed according to newness and significance, unless all defects have been assessed, in which case the method ends. For defects that are new and significant, a lookup is performed to determine how the defect is fixed, the tools required, and the parts required. Then, a subsequent lookup is made to determine whether personnel or equipment tasked (or taskable) to the defect possess the necessary tools, parts, or other resources. If so, the defect is stored in a list of addressable defects, and if not, the defect is stored in a list of follow-up defects. The list of addressable defects is thereafter sorted by impact (e.g., amount of power lost due to defect). The counter is then reset and a loop is run over the defects of the addressable list whereby the time required to fix each defect is compared to the time available to fix the defects by the personnel or equipment tasked (or taskable) to address the defect. If the first addressable task assessed takes more time than the time available, it is stored in the list of follow-up defects (or, alternatively, a different list for later action) and the counter is incremented to move to the next addressable task. If the first addressable task assessed takes less time than the time available, it is stored in a list of immediate work order items, and the time required for the first addressable task is decremented from the time available and the counter is incremented to move to the next addressable task. Once no addressable tasks remain that can fit in the remaining available time, the various lists (addressable with sufficient available time, addressable without sufficient available time, follow-up, not new or not substantial) can be synchronized with a server or enterprise system. In embodiments, interactive checklists can be generated from the list of immediate work order items (e.g., addressable with sufficient time available). Diagrams or depictions showing the defect locations within an asset can be provided. The lists and checklists can be updated and re-synchronized based on the activity of the maintenance personnel or other repairs occurring.

In embodiments, one or more methodologies herein can be combined in any order, or aspects of methodologies can be re-ordered. Methodologies or aspects thereof may be performed simultaneously or in conjunction. In this manner, the methodologies described and other aspects of systems 100 or 200 can be implemented in integrated manners to provide asset management. Methodologies 500 can proceed iteratively until all anomalies are identified and/or an entire asset or group of assets is inspected. Methodology 600 can proceed iteratively until all anomalies are addressed or further resources are unavailable to address any anomaly.

While systems and methodologies herein are described separately, it is understood that techniques, functionality, routines, and aspects of the systems can be performed by or implemented in the methodologies, and vice versa.

In another aspect, the present disclosure is implemented primarily in hardware using, for example, hardware components, such as application specific integrated circuits (ASIC). Implementation of the hardware state machine to perform the functions described herein will be apparent to persons skilled in the relevant art(s). In yet another aspect, the present disclosure is implemented using a combination of both the hardware and the software. In another aspect, the present disclosure is implemented using software.

Various aspects disclosed herein are to be taken in the illustrative and explanatory sense, and should in no way be construed as limiting of the present disclosure. All numerical terms, such as, but not limited to, “first” and “second” or any other ordinary or numerical terms, should also be taken only as identifiers, to assist the reader's understanding of the various aspects, variations, components, or modifications of the present disclosure, and may not create any limitations, particularly as to the order, or preference, of any aspect, variation, component or modification relative to, or over, another aspect, variation, component or modification.

It is to be understood that individual features shown or described for one aspect may be combined with individual features shown or described for another aspect. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

The present disclosure is described herein with reference to system architecture, block diagrams, flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These software elements may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data-processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational steps to be performed on the computer or other programmable apparatus to produce a computer-implemented process, such that the instructions that execute on the computer or other programmable apparatus provide steps for implementing the functions specified in the flowchart block or blocks. In an aspect, the computer program instructions may be executed on any remote-hosted application framework, for example, by a processor associated with a cloud server.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, et cetera. Practitioners will appreciate that the illustrated steps described herein may comprise in any number of configurations including the use of windows, web pages, hypertexts, hyperlinks, web forms, popup windows, prompts, and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The systems, methods and computer program products disclosed in conjunction with various aspects of the present disclosure are embodied in systems and methods for facilitating multiple types of communications in systems and networks discussed herein.

Methodologies herein are described with specific aspects for ease of explanation with respect to various embodiments. However, methodologies embraced under the scope and spirit of the disclosure may vary, to include excluding particular aspects or comparisons described.

While aspects of the present disclosure have been particularly shown and described with reference to the examples above, it will be understood by those skilled in the art that various combinations of the disclosed aspects or additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

What is claimed is:

1. An unmanned aerial system (UAS) comprising:
a propeller assembly configured to propel the UAS;
a location sensor configured to determine location data of the UAS;
a collection sensor configured to collect asset data associated with an asset of an asset class;
a UAS computer including a processor and memory, and an interface configured to receive the location data from the location sensor and the asset data from the collection sensor, wherein the memory stores:
an asset map representing the asset,
anomaly data modeling anomalies associated with the asset class, and instructions when executed by the processor are configured to effectuate operations comprising:
detecting an anomaly in the asset data based on the asset map and the anomaly data,
classifying the anomaly based on the anomaly data,
locating the anomaly based on the asset map, and
generating result data including anomaly location information and anomaly classification information;
a transmitter configured to transmit the result data; and
a power supply configured to provide power to the propeller assembly, the location sensor, the collection sensor, the UAS computer, and the transmitter.

2. The UAS of claim 1, comprising:
a flight computer configured to control the propeller assembly.

3. The UAS of claim 1, wherein the instructions when executed by the processor are configured to effectuate operations comprising:
locating one or more additional anomalies in the asset data based on the asset map and the anomaly data.

4. The UAS of claim 3, wherein the instructions when executed by the processor are configured to effectuate operations comprising:
deduplicating the anomaly and the one or more additional anomalies before generating the result data, wherein the one or more additional anomalies includes two or more views of the asset, and wherein the locating the anomaly and locating the one or more additional anomalies identifies the anomaly two or more times based on separate portions of the asset data.

5. The UAS of claim 4, wherein the instructions when executed by the processor are configured to effectuate operations comprising:
modifying the anomaly location information or the anomaly classification information based on locating the anomaly and locating the one or more additional anomalies.

6. The UAS of claim 1, wherein the anomaly location information describes the anomaly with respect to the asset map.

7. The UAS of claim 1, wherein the instructions when executed by the processor are configured to effectuate operations comprising:
projecting the asset data into three dimensional space based on the asset map and location data.

8. The UAS of claim 1, wherein the instructions when executed by the processor are configured to effectuate operations comprising:
determining a confidence level associated with at least one of the anomaly location information and the anomaly classification information.

9. The UAS of claim 1, wherein the transmitter is communicatively coupled with a ground station.

10. A method, comprising:
collecting, using a collection sensor of an unmanned aerial system (UAS), asset data associated with an asset of an asset class;
detecting, using a UAS computer aboard the UAS, an anomaly in the asset data based on an asset map and anomaly data, wherein the asset map represents the asset, and wherein the anomaly data models anomalies associated with the asset class;
classifying, using the UAS computer, the anomaly based on the anomaly data;
locating, using the UAS computer, the anomaly based on the asset map;
generating, using the UAS computer, result data including anomaly location information and anomaly classification information; and
transmitting the result data.

11. The method of claim 10, comprising:
determining a UAS location, using a location sensor of the UAS, the UAS.

12. The method of claim 11, wherein locating the anomaly is based on the UAS location.

13. The method of claim 10, comprising:
locating one or more additional anomalies in the asset data based on the asset map and the anomaly data.

14. The method of claim 13, comprising:
deduplicating the anomaly and the one or more additional anomalies before generating the result data, wherein the one or more additional anomalies includes two or more views of the asset, and wherein the locating the anomaly and locating the one or more additional anomalies identifies the anomaly two or more times based on separate portions of the asset data.

15. The method of claim 14, comprising:
modifying the anomaly location information or the anomaly classification information based on locating the anomaly and locating the one or more additional anomalies.

16. The method of claim 10, wherein the anomaly location information describes the anomaly with respect to the asset map.

17. The method of claim 10, comprising:
projecting the asset data into three dimensional space based on the asset map and location data.

18. The method of claim 10, comprising:
determining a confidence level associated with at least one of the anomaly location information and the anomaly classification information.

19. A server, comprising:
an anomaly interface configured to receive anomaly result data, wherein the anomaly result data is derived from a subset of asset data by an unmanned aerial system (UAS) by comparing the asset data collected by the UAS to an asset map and anomaly data using a computer aboard the UAS;
an anomaly database configured to store the anomaly result data; and
a maintenance interface configured to provide at least a portion of the anomaly result data to a user device.

20. The server of claim 19, comprising:
a training database configured to store training data for developing the anomaly data, wherein the training data includes at least a portion of the anomaly result data.
